(19) United States
(12) Patent Application Publication
(10) Pub. No.: US 2013/0218696 A1
(43) Pub. Date: Aug. 22, 2013

(54) SYSTEM AND METHOD TO FACILITATE THE REPORTING OF SALES TRANSACTIONS

(71) Applicant: Leonard Eisner, Morganville, NJ (US)

(72) Inventor: Leonard Eisner, Morganville, NJ (US)

(21) Appl. No.: 13/774,271

(22) Filed: Feb. 22, 2013

Related U.S. Application Data
(60) Provisional application No. 61/601,798, filed on Feb. 22, 2012.

(51) Int. Cl. G06Q 40/00

(52) U.S. Cl. CPC G06Q 40/103
USPC 705/19; 705/31

(57) ABSTRACT

A system and method is provided for promoting reporting sales made by merchants to a taxing authority. Such a method includes entering data that denotes each sale made by the seller into a processor of a computer system. In response to the entry of the data, the method further includes automatically recording, in a memory of the computer system, data from which the amount of tax due from the seller in respect of the sales can be ascertained and providing to a buyer in each such sale a reward which enables the buyer to be eligible for a benefit from the taxing authority. The providing step is performed at least in part by an automatic function of the processor so that the rewards are provided only in response to the entry of data denoting sales.

### CROSS-REFERENCE TO RELATED APPLICATION

The present application claims the benefit of the filing date of U.S. Provision Application No. 61/601,798 filed Feb. 22, 2012, the disclosure of which is hereby incorporated herein by reference.

### BACKGROUND OF THE INVENTION

The Internal Revenue Service (IRS) of the United States has estimated that the tax gap, money owed by taxpayers but which is never paid to the IRS, was approximately $385 billion in 2006. Such a gap constituted an approximately 14 percent noncompliance rate accounting for enforcement efforts and late payments received (without these, the noncompliance rate was estimated to be 17 percent or $450 billion). In an effort to close the tax gap, the IRS has developed a number of initiatives to improve the noncompliance rate. For example, starting in 2011, organizations that process credit and debit card transactions for merchants must report the total amount of these transactions to the IRS and to the merchants themselves annually.

Besides the underreporting of credit card transactions, another major contributor to the tax gap is the non-reporting and underreporting of cash transactions between merchants and consumers. In many cases, especially at establishments that have cash as the majority form of payment, e.g., bagel shops, pizzerias, and video stores, a receipt may not be given by a merchant and thus no record of the transaction exists. Without a record, a merchant may simply keep any money given by a consumer as a payment of sales taxes, instead of forwarding that money to the sales tax authority. Alternatively, the merchant may simply neglect to charge for sales taxes. In either case, the merchant avoids having to report the sales transaction and consequently avoids any requirement to pay sales taxes to the government authority. By underreporting sales, the merchant can also avoid other taxes such as income taxes. The same problems occur in jurisdictions where a value added tax is levied instead of, or in addition to, a sales tax.

One known method to encourage the reporting of gross income impacted by cash transactions is to require cash-based businesses to obtain an employer identification number (EIN). Subsequently, the cash-based business must then provide an income statement to the IRS by a designated time frame. In exchange for accurately reporting gross income, the federal and local governments may provide social welfare benefits such as medical coverage, free or reduced tuition, free or reduced rent, retirement income guarantees, or a combination of these benefits. However, despite these methods, underreporting remains a widespread practice.

U.S. Pat. No. 5,875,433 to Francisco et al., the disclosure of which is hereby incorporated by reference herein, describes a retailer point of sale terminal which computes the sales tax owed by a consumer on the transaction and forwards this data to a remote location such as a state government taxing authority. The consumer may request a receipt from the register as evidence that any sales tax paid by the consumer will be turned over to the proper government authority. However, such a method does not provide an incentive to consumers to pay the sales tax or to request a receipt for cash transactions. The consumer obtains no direct, tangible benefit by demanding a receipt, and paying sales tax for an otherwise untraceable cash transaction. The customer may not wish to request a receipt. Thus, a merchant can defeat the system by simply not recording the sale. Neither the merchant nor the customer has an incentive to catch such cheating. Attempts to catch such cheating by auditing merchants' records after the fact are often ineffective.

Point-of-sale terminals are known to generate rewards such as tickets, coupons, certificates, or vouchers for discounts as incentives to consumers to perform various actions such as to provide customer information, to use cash or a debit card, to purchase a certain product or even to bring a bag for groceries rather than using the bags on-hand at the grocer. However, these capabilities have not been useful in providing incentives for reporting of sales by merchants.

Therefore, there exists a need for a more efficacious method for facilitating the collection of taxes owed from cash-based transactions.

### BRIEF SUMMARY OF THE INVENTION

One aspect of the invention provides a method for promoting reporting to a taxing authority of sales made by one or more sellers. A method according to this aspect of the invention desirably includes steps performed in response to entry of data denoting sales made by a seller into a processor of a computer system. In response to such entry, the processor desirably automatically records, in a memory of the computer system, data from which the amount of tax due from the seller in respect of the sales can be ascertained. Also in response to such entry, the processor desirably operates to provide to a buyer in one such sale a reward which enables the buyer to be eligible for a benefit from the taxing authority. The providing step desirably is performed at least in part by an automatic function of the processor so that the rewards are provided only in response to entry of data denoting sales.

For example, data denoting the reward can be provided to the buyer as, for example, by providing the buyer with a tangible object bearing the data. For example, the data denoting the reward may be printed on a sales receipt of the type generated by a point-of-sale terminal. The reward may be, for example, the right to enter a lottery operated on behalf of the taxing authority. The buyer may obtain the value of the reward, and an entry into the lottery, by submitting the data denoting the reward to the taxing authority. Because the buyer wants the reward, the buyer will have an incentive to demand that the merchant record the sale in the system.

Further aspects of the invention provide systems for use in such methods and information-bearing media having instructions for operation of a processor to perform such methods.

### BRIEF DESCRIPTION OF THE DRAWINGS

FIG. 1 is a functional block diagram depicting a system according to one embodiment of the invention.

FIGS. 2, 3 and 4 are flowcharts depicting processes used in operation of the system depicted in FIG. 1.

### DETAILED DESCRIPTION

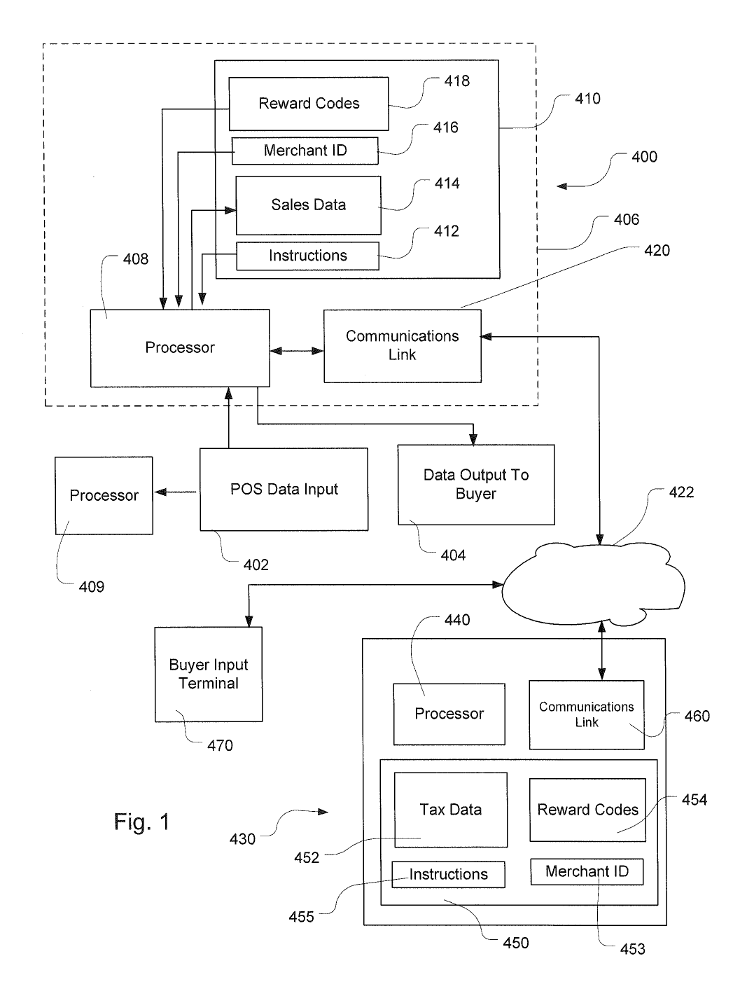

A system in accordance with one embodiment of the invention, schematically depicted in FIG. 1, includes numerous merchant terminals 400, only one of which is shown for simplicity of illustration. Each merchant terminal includes a conventional input element 402 such as a keyboard of the type commonly used in point-of-sale (“POS”) terminals. Input element 402 may also include other conventional input devices such as bar code scanners for reading codes on merchandise such as bar codes. Each merchant terminal further includes an output device 404 for conveying information to a buyer. For example, the output device 404 may be a conventional printer of the type commonly used to print receipts in a conventional point-of-sale terminal, a display screen, or other output device. The merchant terminal further includes a secure processing system 406. The secure processing system includes a processor 408 interconnected with a memory 410. Memory 410 is arranged to store program instructions 412 for processor 408 to perform the operations discussed below. The program instructions desirably are in non-transitory form. Memory 410 also stores sales data 414 for sales made at the merchant terminal, a merchant identification 416 identifying the merchant employing terminal 400, and reward codes 418. As further discussed below, the reward codes are codes provided by a taxing authority and used to authenticate rewards that will be provided to buyers by the merchant employing the terminal. The merchant terminal 400 further includes a communications link 420 as, for example, a link to a public switched telephone network, the internet, or other network 422. Terminal 400 may also include a processor 409 arranged to perform the functions of a conventional POS terminal as, for example, price verification, interfacing with an inventory system maintained by the merchant and the like. Each merchant terminal 400 is maintained under the control of a seller, and typically is located on the premises occupied by the seller. At least the input element 402 and output device 404 desirably are located at the point where sales are made.

Processor 408 and memory 410 desirably are secure elements that incorporate technical measures which either prevent tampering with the internal operations of processor 408 or the data stored within memory 410 or which make it apparent when such tampering has occurred. Such technical measures are well-known in the art and may include, for example, physical structures such as a secure housing enclosing these elements, encryption of data stored in memory 410, data structures such as hashing codes calculated based on the contents of the data in the memory according to a secret routine, and the like.

The system further includes a computer system 430 operated under the control of a taxing authority. For example, computer system 430 may be operated by the taxing authority, by a third party under contract with the taxing authority, or by a combination of the taxing authority and a third party. Computer system 430 includes a processor 440, a memory 450, and a communications link, 460. Memory 450 is arranged to store tax data 452 associated with individual merchants as, for example, in a database linking each merchant with a record of sales tax owed by the merchant or other information from which the tax owed by the merchant can be ascertained. Memory 450 is also arranged to store a list of valid reward codes 454 which have or could be provided to individual merchants in a database. The database is arranged so that each reward code is associated with the merchant who has received such reward code from the taxing authority as discussed below. For example, a portion of the reward code may include a number that identifies a merchant. The memory 450 also stores a list of valid merchant identification numbers 453, as well as instructions 455 which direct the processor 440 to perform the operations discussed below. Such instructions desirably are in non-transitory form.

The system further includes one or more buyer input terminals 470. The buyer input terminals may be any form of terminal that can contact the taxing authority computer system 430 over a network such as network 422. As explained below, the buyer input terminals are used by buyers to enter certain data. Because these terminals need not be secure, a buyer's personal computer, personal digital assistant, smart phone or other data processing device can be used as a buyer input terminal. Buyer input terminals 470 may also be provided as public terminals as, for example, terminals installed at merchant locations. For example, automatic teller machines may be arranged to operate as buyer input terminals, which can be actuated by buyers supplying reward information as discussed below.

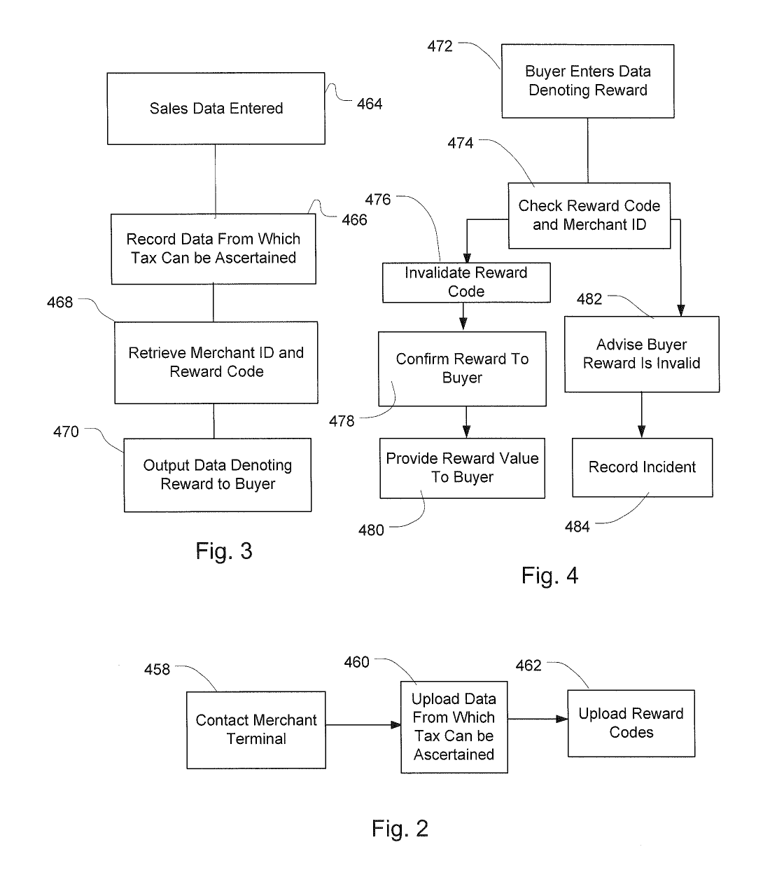

In a process according to one embodiment of the invention, taxing authority computer system 430 periodically runs a routine as shown in FIG. 2. Merely by way of example, this routine may be run daily, monthly, or quarterly. In step 458, the taxing authority computer system 430 contacts each merchant terminal 400 through network 422 and instructs the processor of the merchant terminal 400 to communicate the sales data 414 stored in that terminal. In step 460, the taxing authority computer system 430 takes the sales data from the individual merchant terminal and updates the tax data 452 (FIG. 1) associated with the merchant operating that terminal based on the sales data. For example, in a simple tax regime, where the tax due is simply a multiple of the total sales made by the merchant, the sales data 414 recorded in memory 410 may be simply a total aggregate of all sales made through the terminal 400 since the last upload by the taxing authority computer system 430. In this case, processor 440 of the taxing authority computer system 430 may simply read the total, compute the tax due from the merchant, add that amount to a sum already stored within tax data 452, and store the new sum as the tax due from the merchant. Such sum is stored in association with data identifying the merchant.

In step 462, the taxing authority computer system 430 also generates unique codes, referred to herein as “reward codes.” The taxing authority computer system 430 uploads the set of reward codes to a particular merchant terminal 400 and records the reward codes sent to the merchant in a database of reward codes 454 in association with the identification of the merchant operating the particular terminal. Thus, the taxing authority computer system 430 maintains a record of reward codes validly issued to each merchant terminal 400 and the identification of that merchant terminal. After concluding step 462, the taxing authority computer system 430 repeats the process with the next merchant terminal, until the same process has been performed for all merchant terminals.

When a buyer makes a purchase at the establishment where a merchant terminal 400 is located, the merchant terminal executes the series of operations shown in FIG. 3. In step 464, the merchant enters data concerning the sale into point-of-sale input 402. This step of the process can be performed in the normal way that the merchant would enter the sales data into a conventional POS terminal. In step 466, secure processor 408 of the merchant computer system 400 records sales data pertaining to the sale from which the tax due on the sale can be ascertained. In a simple tax jurisdiction, where the tax due is simply a multiple of the amount of the sale, the sales data may consist simply of the sale amount itself. The sale amount itself can be recorded directly, so that the sales data 414 in memory 410 consists of sales amounts for successive transactions. Such a record constitutes an electronic version of a traditional cash register tape. In another variant, the sales data 414 stored in memory 410 may be simply an aggregate amount of all sales recorded since the sales data was last uploaded by the taxing authority computer system 430. In this arrangement, processor 408 is arranged to retrieve the stored aggregate amount from memory 410, add the amount of the current sale to the aggregate, and record the total as the new aggregate sales data. Processor 408 may be arranged to reset the aggregate to zero when the taxing authority computer system 430 uploads the sales data as discussed above with reference to FIG. 2.

In the next step 468, processor 408 of the merchant computer system retrieves the merchant identification code 416 from memory 410 and also retrieves a reward code 418 from the memory. Processor 408 deletes the retrieved reward code 418 from memory 410 so that the retrieved reward code cannot be reused. In the next step 470, the processor 408 of the merchant computer system 400 outputs the data that denotes a reward to the buyer through the data output device 404. The data denoting the reward desirably includes the reward code, the merchant identification number of the merchant, and data denoting the value associated with the reward. The value associated with the reward may be directly related to the amount of the sale that was input. For example, the value may be directly proportional to the sales amount, in which case, the data denoting the reward may include simply the sales amount or some other number proportional to the sales amount.

The data output device 404 conveys the data denoting the reward to the buyer in any form that the buyer can use to claim the reward. Where the output device is a printer, the output device may simply print the data denoting the reward on a ticket given to the buyer. The ticket may be the sales receipt which is normally given to the buyer in connection with a sales transaction. Thus, the ticket and sales receipt may include data generated by point-of-sale data processor 409 and commonly found on sales receipts, such as the type of goods purchased and the individual price of each item purchased. The data denoting the reward may be printed on the receipt, or otherwise provided to the buyer, in human-readable form, in machine-readable form such as a bar code or other printed code, or both. In this embodiment, as discussed further below, the data denoting the reward can be used by the buyer to enter a lottery operated on behalf of the taxing authority. Thus, the reward given to the buyer constitutes a license which allows the buyer to enter the lottery.

The step of outputting data denoting a reward is performed by processor 408 if, and only if, sales data has been entered into processor 408. Stated another way, processor 408 operates to output data denoting a reward in response to entry of the sales data into the processor. In the particular routine shown in FIG. 3, the data denoting the reward is output only after the sales data from which the tax due can be ascertained has been recorded into memory 410 in step 466. Because reward codes 418 stored in memory 410 can only be retrieved by processor 408 and the processor will only retrieve a reward code responsive to entry of sales data into the processor, the merchant cannot provide data denoting a reward that includes a valid reward code to a customer unless the merchant has first entered the sales data. The reward codes thus serve as a security feature that precludes a merchant from issuing data denoting a reward without recording sales.

The buyer may then obtain the benefit of the reward by entering the data denoting the reward through a buyer input terminal 470. For example, where the ticket includes the reward data in machine-readable form, the buyer may simply scan the ticket at the terminal.

When a buyer enters the data denoting the reward into a buyer input terminal 470 and such information is communicated to the computer system 430 at the taxing authority, processor 440 of the taxing authority computer system executes operations as shown in FIG. 4. In response to entry by the buyer of the data denoting the reward (step 472), processor 440 checks the merchant identification code included in the data against the list of valid merchant identification codes 453 stored in memory 450 and confirms that the merchant identification code is valid at step 474. Processor 440 also retrieves data from memory 450 denoting the reward codes 454 which were issued to the particular merchant denoted by the merchant identification number in the data entered by the buyer. The processor 440 then confirms that the reward code entered by the buyer matches one of the reward codes associated with the particular merchant identification number. If the data matches, the processor 440 of the taxing authority computer system 430 invalidates the reward code to prevent its reuse in the future at step 476. In this step, the processor 440 may simply delete the reward code that has just been checked from the list of valid reward codes associated with the merchant as stored in memory 450.

Processor 440 then issues a message through the communications link 460 to the buyer input terminal 470 confirming to the buyer at step 478 that the buyer has provided valid data that denotes a reward, and that the buyer has now received the reward. Desirably, this confirmation includes at step 480 an indication of the value of the reward which is associated with the amount of the sale that generated the reward. For example, the processor may read the data associated with the value of the sale from the data entered by the buyer and confirm to the buyer that “you have earned a reward for reporting a sale of $X.” Thus, the buyer can verify that, in fact, the merchant has provided the buyer with a reward appropriate for the amount of the purchase made by the buyer.

At a next step 480, the processor 440 executes operations necessary to provide the value of the reward to the buyer. In this particular embodiment, the reward gives the buyer the right to an entry into an instant lottery. Thus, the taxing authority computer system provides the value of the reward by entering the buyer into an instant lottery. Processor 440 of the taxing authority computer system 430 operates a random draw process. In this process, the processor generates or obtains a random number and determines whether that random number falls within a range of numbers associated with the particular entry. If so, the entry is a winner, and is entitled to a predetermined prize. If not, the entry is a losing one and obtains no prize. In the particular embodiment depicted, the chances of winning are proportional to the sale amount. Therefore, the processor sets the range of random numbers used in the random draw process in proportion to the amount of the sale denoted by the data entered by the buyer. The larger the amount of the sale, the greater the chances of winning.

In response to the outcome of the random draw process, processor 440 takes action to inform the buyer of the outcome. If the random draw process indicates a “win,” the processor displays a message at the buyer input terminal that indicates the amount of the win, and also provides appropriate information or actions for the buyer to claim the prize. For example, the processor may simply direct display of a win code and information as to where the buyer can mail the winning code to claim the prize. Preferably, however, the processor directs display of the winning amount and requests information from the buyer as, for example, the buyer's name, address, and taxpayer identification number. In response to entry of this information, the processor directs forwarding of this identifying information and the amount of the prize won to a separate system (not shown) for issuance of a check or electronic payment as appropriate. If the results of the random draw process indicate a loss, the taxing authority computer system simply sends a message denoting the loss as, for example, “sorry, you did not win this time; please try again.”

If the comparisons in step 474 indicate that the data entered by the buyer is invalid, in that it contains an incorrect reward code, an incorrect merchant identification, or both, processor 440 branches to step 482. In this step, the processor sends a message to the buyer input terminal indicating that the entry made by the buyer is invalid as, for example, “your entry is invalid.” Thus, the buyer will understand immediately that the merchant did not give him the reward associated with the sale. The processor 440 may also instruct the buyer input terminal to display questions to the buyer as, for example, the name and address of the merchant who issued the invalid reward. Processor 440 then records data pertaining to the invalid reward at step 484 into memory 450. (FIG. 1.) The recorded data may include, for example, the merchant identification data, the reward code, and the amount of the sale indicated by the data entered by the buyer, as well as the data provided by the buyer in response to questions at step 482. The taxing authority can use this data to identify merchants who attempt to cheat the system.

The system and methods as discussed above provide a powerful incentive for the merchant to enter sales, including cash sales, into the point-of-sale terminal. Buyers will demand their reward data with each sale so that they can obtain the benefits, such as lottery entries, associated with the reward. To enhance such demand, the taxing authority can use advertisements or other public communication reminding the public of the benefits to be obtained by demanding their rewards. If the merchant does not properly record a sale, the buyer will learn promptly that he or she has not been given the reward which he or she should have received if the merchant had properly recorded the sale. If the merchant records the sale for less than the correct amount, the buyer will learn promptly that he or she has been given a reward associated with a lesser amount and thus has been cheated. The taxing authority, of course, can track the taxes due from each merchant based on the sales data retrieved from the respective merchant computer systems.

Numerous variations of the features discussed above can be used. For example, in one such variant, the reward given to the buyer is not an entry into a lottery, but rather is a rebate on taxes owed by the buyer to the taxing authority as, for example, income taxes. In this variant, at step 480, the taxing authority computer system provides the reward value to the buyer by awarding the buyer a rebate value associated with the reward. The processor of the taxing authority computer system may transmit a message to the buyer input terminal asking the buyer to input his or her identification data as, for example, name, address, and taxpayer identification number, so that the rebate value can be applied properly.

In a further embodiment, the buyer input terminals are omitted and the merchant computer systems 400 perform the functions of the buyer input terminal. In such a variant, processor 408 of the merchant terminal transmits the data denoting the reward directly to the taxing authority computer system 430 via communications links 420 and network 422, and the taxing authority computer system sends messages to be displayed back through the network to the merchant computer system 400, whereupon processor 408 actuates the data output to the buyer 404 to display the messages. In this instance, the data output to the buyer may be simply in the form of a display screen. For example, upon conclusion of a sale, the secure processor 408 sends the reward code, merchant identification, and data indicating the sale amount to the taxing authority computer system 430, and the taxing authority computer system instructs the merchant computer system 400 to display messages similar to those discussed above with reference to the buyer input terminal 470. Here again, the data denoting the reward is communicated to the buyer. Thus, immediately upon conclusion of the sale, the buyer will see a message indicating that he or she has been given a valid reward and the amount of the sale associated with the reward, and the buyer will see whether or not he or she has won an award. For example, the reward may be an automatic entry into a lottery. If the particular entry results in a “win” in the random drawing process, the taxing authority computer system 430 may send a message to the merchant computer system 400 directing the merchant computer system to display the amount won and requesting the merchant to pay the amount won directly to the buyer. The taxing authority computer system 430 will compensate the merchant for such payment by deducting the amount to be paid from the tax due from the merchant as, for example, by modifying the tax due data 452 held in memory 450. In this embodiment as well, however, the buyer is provided with information denoting the reward through the displays made by the merchant computer system. Here again, the buyer can determine immediately if he or she has or has not received a valid reward appropriate to the purchase.

In a further variant, the reward codes may be generated by the merchant computer system 400 using a secure algorithm and the merchant identification number associated with the merchant computer system 400. In this instance, the taxing authority computer system 430 may operate to verify a reward code submitted by a buyer or submitted by the merchant computer system 400 using a similar algorithm and the merchant identification number. In a further variant, the reward codes may be omitted entirely. For example, where the data denoting the reward is transmitted directly by the merchant computer system, the taxing authority computer system may include appropriate security measures to verify that the taxing authority computer system is, in fact, receiving messages from the merchant computer system associated with a particular merchant. Security measures sufficient to confirm the identity of a remote computer are known per se in the art and are not discussed further herein.

In a yet another variant, the reward provided to the buyer may be in the form of an entry into a lottery with periodic drawings, or a license to enter such a lottery, rather than an instant lottery with drawings upon each entry. In a simple embodiment of such a system, the merchant computer system may provide information denoting the reward code, the merchant identification, and information associated with the value of the sale to the buyer, and the buyer may simply save this information. For example, where the information denoting the reward is provided on a printed document such as a receipt serving as a ticket, the buyer may simply save these documents. The taxing authority may select winning reward codes by a random process periodically and announce the winning reward codes publicly, so that the buyer holding the winning reward code can claim the prize.

In a still further variant, the reward codes themselves may serve as an indication of the value of the sale. For example, each reward code may be associated with a unit of value, so that a buyer making a purchase for a first amount receives one reward code, a buyer making a purchase for a larger amount receives two reward codes, and a buyer making a purchase for a still larger amount receives three reward codes, and so on. In such an embodiment, the buyer can ascertain that the merchant has given him the correct reward for the purchase amount by checking the number of reward codes.

In a further variant, the functions performed by the secure processor 408 and memory 410 of the merchant computer system may be performed by the taxing authority computer system. Thus, the POS data denoting the amount of a sale entered through the POS data input 402 is transmitted directly to the taxing authority computer system. Based on the identity of the terminal or on a merchant identification transmitted along with this data, the taxing authority computer system identifies the merchant and updates a record of tax due based on the individual sale. Here again, responsive to entry of data denoting the sale, the processor 440 of the taxing authority computer system performs the steps necessary to provide an indication to the buyer that he or she has received a reward and to provide the value associated with the reward. For example, the taxing authority computer system may transmit a message to the merchant computer system actuating the data output to the buyer to provide either a printed receipt or a display indicating that the buyer has received an entry in a lottery or other benefit.

In the embodiments discussed above, the information necessary to ascertain the tax due from the merchant is simply the amount of the sale. In other instances, the tax due from the merchant may vary with the type of goods sold. In this instance, the secure processor 408 of the merchant computer system may interact with the point-of-sale processor 409 to retrieve the type of goods associated with a sale and to record in the sales data 414 (FIG. 1) the type or types of goods sold and the amount of the sale associated with each type, so that the total tax due in respect of the sale can be ascertained. In a variant, the secure processor 408 of the merchant computer system may use information concerning the type or types of goods sold and the amount of each type sold to compute the aggregate amount of tax due in respect of the sale, and this aggregate amount can be recorded in the sales data 414. The same processes can be used where the sales data is directly recorded by the taxing authority computer system.

In certain embodiments discussed above, the buyer is provided with a ticket incorporating the information denoting the reward. However, this information need not be provided to the buyer in tangible form. For example, where the buyer is in possession of an electronic device such as a smart phone, personal digital assistant, or the like, the information can be transmitted to the buyer's device and stored therein. Also, where the buyer is given an immediate benefit such as entry into an instant lottery as discussed above, the information denoting the reward can be simply displayed to the buyer on a display screen or the like.

In the embodiments discussed above, the taxing authority computer system records data from which the tax due in respect of past sales by each merchant be can obtained. In a further embodiment, the taxing authority computer system can dispense the right to give rewards in respect of future sales in exchange for payments made by a merchant. For example, where a reward code is associated with a particular sales amount and thus with a particular amount of tax due, the merchant computer system may request reward codes by providing a payment to the taxing authority computer system. The merchant thus pays the sales taxes due in advance. The merchant computer system stores the reward codes and provides the same to buyers in response to sales data entered into the merchant computer system. The merchant has an incentive to pay the tax and obtain the reward codes, because customers will not be satisfied if they do not receive rewards for each sale.

In yet another variant, the merchant computer system can give rewards without using a reward code. The secure processor of the merchant computer system automatically keeps a record in memory of the number of rewards given out by the system, the value of such rewards, or both. The taxing authority computer system can read such record periodically and thus can track the number of rewards given and charge the merchant accordingly.

In the embodiments discussed above, the system is used to encourage reporting of tax information with respect to all sales made by merchants. However, because sales made by credit card, debit card, checks, and other media of payment involving a bank or other payment processing entity can be readily tracked using other techniques, the system may be made applicable only to cash transactions or transactions involving cash equivalents, such as barter or bearer-denominated negotiable instruments. Also, although the system has been discussed above with reference to sales taxes, the data gathered using the system can be employed to collect other taxes such as income and profits taxes. In such an arrangement, the data collected by the taxing authority computer system desirably includes the total amount of sales made through each merchant computer system. Moreover, the party operating the taxing authority computer system may periodically send a statement of the total amount of recorded sales to both the merchant and the taxing authority. Such statements may be similar to IRS Form 1099s that provide a statement of income to taxpayers and to the taxing authority. When the merchants receive the Form 1099s, the merchants are prompted to accurately report sales on their filed tax returns.

In a further variant, a large merchant having multiple POS terminals may be provided with a centralized merchant computer system linked to all of the POS terminals.

Although functional elements of certain systems have been shown in functional block form, it should be appreciated that the various elements can be split and combined with one another. For example, plural memories can be used to store the data stored in the single memory 410 shown in FIG. 1. Likewise, although only a single secure processor 408 in the merchant computer system and a single processor 440 are shown in the tax authority computer system, the functions of these elements can be performed by numerous physical processing elements that can be separate from one another, and may even be in plural locations remote from one another. Also, the functions performed by secure processor 408 and POS processor 409 can be performed by a single processor. However, such single processor desirably provides security similar to that discussed above with reference to secure processor 408.

As these and other variations and combinations of the features discussed above can be utilized without departing from the present invention, the foregoing description of the preferred embodiments should be taken by way of illustration rather than by way of limitation of the invention as defined by the claims.

In the Brief Summary of the Invention above, the Detailed Description of the invention herein, the claims below, and in the accompanying drawings, reference is made to particular features (e.g., method steps) of the invention. It is to be understood that the disclosure of the invention in this specification includes all possible combinations of such particular features. For example, where a particular feature is disclosed in the context of a particular aspect, arrangement, or embodiment of the invention, or a particular claim, that feature can also be used, to the extent possible, in combination with and/or in the context of other particular aspects, arrangements, and embodiments of the invention, and in the invention generally.

1. A method for promoting reporting to a taxing authority of sales made by one or more sellers, said method comprising:
entering data denoting each sale made by the seller into a processor of a computer system;
in response to said data entry, automatically recording, in a memory of the computer system, data from which the amount of tax due from the seller in respect of the sales can be ascertained; and
in response to said data entry for each sale, providing to a buyer in each such sale a reward which enables the buyer to be eligible for a benefit from the taxing authority, said providing step being performed at least in part by an automatic function of the processor so that the rewards are provided only in response to said entry of data denoting sales.

2. The method of claim 1, further comprising utilizing the computer system to control access to the rewards so that the taxing authority can do at least one of (i) prevent distribution of the rewards except in response to entry of the data for a sale and (ii) track the amount of rewards distributed by or on behalf of each seller.

3. The method of claim 1, wherein the processor and the memory are maintained under the control of the seller, the method further comprising transmitting to the taxing authority the data from which the amount of tax due from the seller in respect of sales can be ascertained.

4. The method of claim 3, wherein the step of transmitting data to the taxing authority is performed periodically and the step of recording data in the memory is performed so that the memory holds a record from which an amount of tax due from the seller in respect of sales since the last transmission of data to the taxing authority can be ascertained.

5. The method as claimed in claim 1, wherein the computer system including the processor and the memory is maintained under the control of the taxing authority, the method further comprising transmitting data concerning each sale from the seller to the computer system.

6. The method of claim 1, wherein the step of entering data is performed in conjunction with entry of data into a point-of-sale terminal maintained by the seller.

7. The method of claim 1, wherein the reward is at least one of (i) an entry into a drawing for a prize from the taxing authority, (ii) a license to enter a drawing for a prize from the taxing authority, and (iii) a license to obtain a reduction in taxes owed to the taxing authority.

8. The method of claim 1, wherein the step of providing a reward includes providing data denoting the reward to the buyer.

9. The method of claim 8, further comprising the step of providing value associated with the reward to the buyer responsive to submission by the buyer of the data denoting the reward to the taxing authority.

10. The method of claim 9 further comprising the step of automatically verifying data denoting the reward submitted by the buyer and notifying the buyer if the data denoting the reward is invalid.

11. The method of claim 8, wherein the step of providing data denoting the reward includes providing a tangible item bearing the data denoting the reward.

12. The method of claim 11, wherein the data denoting the reward is provided on a receipt providing a record of the sale and the receipt is given to the buyer.

13. The method of claim 1, wherein the benefit from the taxing authority has a first value for a transaction valued at a first amount and the benefit from the taxing authority has a second value for a transaction valued at a second amount.

14. An information-bearing medium having recorded thereon in non-transitory form instructions for actuating a processor of a computer system to perform the steps of a method as claimed in claim 1.

15. A system for maintaining information from which taxes due to a taxing authority from a seller in respect of sales made by the seller to buyers can be ascertained comprising:
a memory; and
a processor operative in response to entry of data denoting a sale to:
(i) automatically record in the memory data from which tax due in respect of such sale; and
(ii) automatically provide data denoting a reward which enables the buyer to be eligible for a benefit from the taxing authority, the processor being operative to provide the data denoting the reward only in response to entry of data denoting a sale.

16. A system as claimed in claim 15 further comprising a data output device connected to the processor and operative to communicate the data denoting the reward to a buyer.

17. The system of claim 16 wherein the data output device is operative to dispense a tangible item bearing indicia denoting the reward.

18. The system of claim 15, wherein the reward is at least one of (i) an entry into a drawing for a prize from the taxing authority, (ii) a license to enter a drawing for a prize from the taxing authority, or (iii) a license to obtain a reduction in taxes owed to a taxing authority.
